(19) United States
(12) Patent Application Publication
(10) Pub. No.: US 2003/0043041 A1
(43) Pub. Date: Mar. 6, 2003

(54) Method and apparatus for facilitating personal attention via wireless networks

(76) Inventors: Rob Zeps, San Diego, CA (US); John Moores JR., Rancho Santa Fe, CA (US); Pertti Visuri, Fallbrook, CA (US); Rebecca Kramer, San Diego, CA (US); Mark James, San Diego, CA (US); Martin Franklin, San Diego, CA (US); Nashina Asaria, San Diego, CA (US); Kurt Kremer, Cardiff, CA (US)

Correspondence Address: BROBECK, PHLEGER & HARRISON LLP, 12390 EL CAMINO REAL, SAN DIEGO, CA, 92130, US

(21) Appl. No.: 09/955,535

(22) Filed: Sep. 12, 2001

Related U.S. Application Data
(63) Continuation-in-part of application No. 09/938,356, filed on Aug. 21, 2001.

(51) Int. Cl. G08B 23/00

(52) U.S. Cl. 340/573.1; 340/572.1; 340/5.81

(57) ABSTRACT

A method and system for identifying individuals, accessing and updating background information regarding such individuals and directing appropriate personal interaction with the individuals through use of an automatically readable tag, such as an RFID tag. Information encoded on the tag is communicated to a computer system that has a database in connection with which identification information encoded on the tag is used as a key to retrieve relevant background information, which is then communicated to a portable display device. The system may also automatically capture an image of an individual being identified and may then transmit the image over a wireless link to the portable display device. The system may employ multiple RFID scanners, various image capture devices, and multiple portable display devices, such as PDA's.

### RELATED APPLICATION

This application is a continuation in part of U.S. application Ser. No. 09/938,356 filed Aug. 21, 2001, of the same title, which is hereby incorporated by reference in its entirety.

### BACKGROUND OF THE INVENTION

1. Field of the Invention

The subject invention relates, in part, to methods and apparatus for facilitating personal interactions and finds application in various areas, including, but not limited to, the identification of individuals, the accessing and updating of background information regarding individuals, and the directing of appropriate personal interaction with such individuals.

2. Description of Related Art

Various environments exist where personal services and products are being rendered such as hospitality environments, casino environments, retail environments, hospital environments, prison environments or marketing situations. In such environments, appropriate interaction with customers is required. Thus, it becomes important to identify a person entering the environment and to provide immediate access to relevant background information concerning that person.

Presently, systems and methods for identifying individuals, accessing background information regarding such individuals, and directing appropriate personal interactions with them typically require some physical contact with the individual as a prelude to being able to conduct any personal service for that individual. Representative of existing methods is the conventional “Name Tag” system where a printed name tag with text noting the individual's name and related information is printed on the face of the tag worn by the individual. This system requires visual contact with the name tag in order to acquire information about the individual before rendering personal service to that individual.

Such systems are time consuming and inconvenient to both the individual being identified and the person or persons delivering the personal service. In an emergency, a person may fail to respond to an individual's needs as a result of the time it takes to gather the relevant information about the individual. A more automated, efficient and reliable system for ensuring that individuals can be identified and that relevant information about them can be accessed is therefore needed.

### SUMMARY

At the end of this application a number of claims are set forth, each of which, according to statute, is presumed valid independently of the validity of the other claims. Accordingly, the following discussion of various features, systems and methods is provided by way of introduction to the ensuing detailed description in order to assist in a more rapid comprehension thereof and is not intended to, and does not, limit the claims in any way.

According to one aspect of the disclosure, a system and method is provided for identifying individuals, accessing and updating background information concerning such individuals, and directing appropriate personal interactions with the individuals. The system employs an automatically readable tag, such as an RFID tag, containing identifying information regarding an individual. Information read from the tag is communicated to a computer system having a database, and the identification information is used as a key for retrieving relevant information regarding the individual. Such information is then communicated to a portable display device such as a pocket personal computer (PC).

According to one illustrative embodiment, an RFID tag contains a number comprising a unique identifier. Once an RFID scanner or reader reads the tag, it generates an RFID Tag Event in the computer system. When the RFID tag is read, the computer system signals a camera to capture an image of the individual carrying the tag. This image and the corresponding number read off the RFID tag are then sent by the computer system to a database, which is then updated with an event ID. This event ID can then be used to locate a file where the image created by the camera is stored. Once the image is stored, a message is sent to a portable display device notifying the user of the display device that a new image is present. The message on the portable display device provides the option of viewing information about the individual whose RFID tag was read. Specific information regarding the individual is stored in particular fields in the database, and may be transmitted to the user. The image of the individual just taken by the camera may also be transmitted to the portable display device.

Thus, a novel aspect of the invention is a method which employs the steps of detecting the presence of an individual by reading an encoded tag associated with that individual, and automatically responding to the detection of the individual by transmitting information regarding that individual to a display device. Further novelty resides in the step of displaying a selected portion of the information to a second individual on a display portion of the display device. Another independently novel aspect of the invention is automatically responding to detection of the individual by capturing an image of the individual and including that image in the information transmitted to the display device. Still another novel feature comprises transmission of status change information from the display device to computerized apparatus storing such status information.

### BRIEF DESCRIPTION OF THE DRAWINGS

Illustrative embodiments implementing methods and apparatus according to the invention will now be discussed in conjunction with the accompanying drawings of which:

FIG. 1 is a schematic system diagram of a first system wherein various methods and apparatus according to the invention are practiced.

FIG. 2 is a schematic system diagram of a second system wherein various methods and apparatus according to the invention are practiced.

FIG. 3 is a flowchart illustrating a method of operation of the system of FIG. 1.

FIG. 4 is a flowchart illustrating operation of an implementation of the embodiment of FIG. 2.

FIG. 5 is a UML (Universal Modeling Language) diagram reflecting the logical architecture of software employed in the illustrative implementation of an embodiment according to FIG. 2.

FIG. 6 is a screen display which may be generated in connection with operation of the illustrative implementation of FIG. 2.

FIG. 7 is a screen display which may be generated in connection with operation of the illustrative implementation of an embodiment of FIG. 2.

FIG. 8 is a schematic system diagram of a third system wherein various methods and apparatus according to the invention are practiced.

FIGS. 9-12 illustrate the structure of an alternate database.

FIG. 13 is a schematic diagram illustrating software components employed in an alternative implementation.

FIG. 14 is a schematic diagram illustrating the Class structure of an RFID reader component.

FIG. 15 is a schematic diagram illustrating the Class structure of a server component.

FIGS. 16 and 17 illustrate display screens useful in coordinating system administration.

FIGS. 18 and 19 illustrate alternative screen displays for use in connection with a portable display device.

### DETAILED DESCRIPTION OF ILLUSTRATIVE EMBODIMENTS

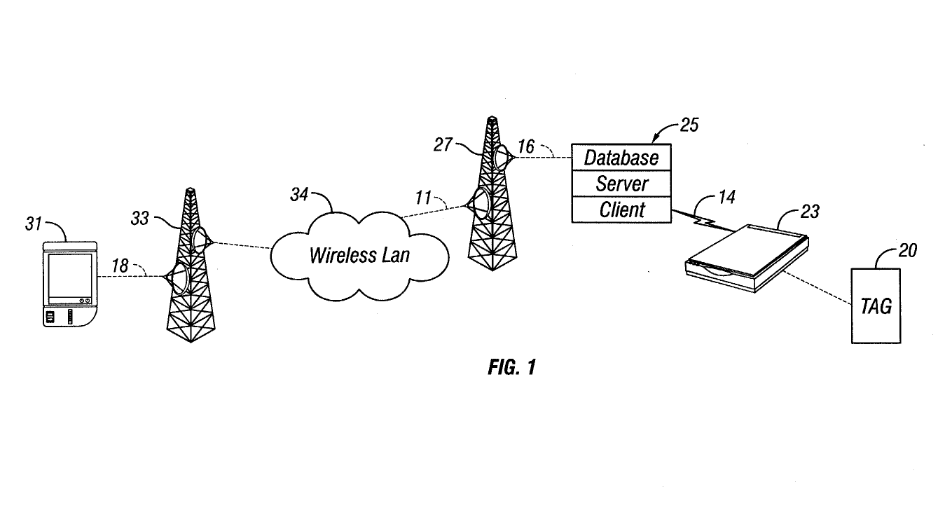

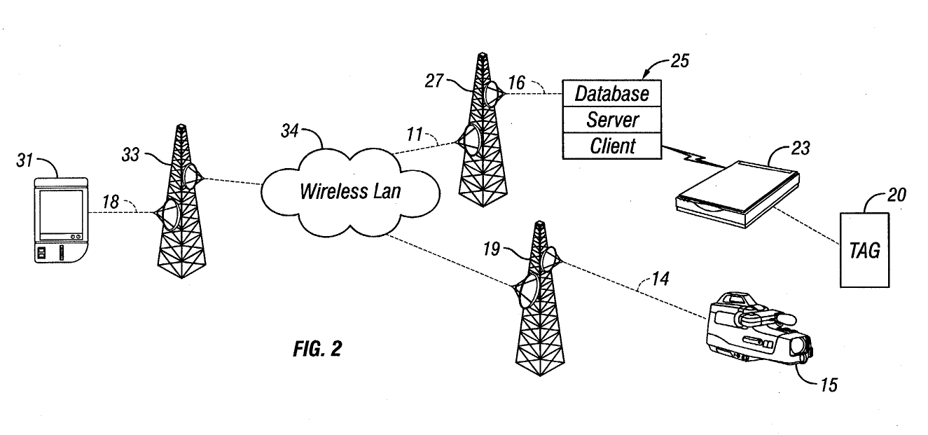

FIGS. 1 and 2 depict two illustrative embodiments of systems 11, 111 for facilitating personal attention, which reflect various methods and apparatus according to the invention. Various modifications and implementations of the methods and apparatus residing in these systems 11, 111 may, of course, be made without departing from the scope and spirit of the invention.

In the embodiment of FIG. 1, a remote frequency identification (RFID) scanner 23 is located at a first site 16. The scanner 23 communicates with a computer 25, which in turn communicates with a wireless link 27. The scanner 23 is a machine arranged to read information regarding an individual, which information is encoded on an RFID tag 20 worn by that individual.

At a second site 18 of the system 11, a portable display device 31 communicates with a second wireless link 33. In the implementation under discussion, the wireless links 27, 33 form a wireless local area network (LAN) 34.

The embodiment of FIG. 2 includes the apparatus of FIG. 1, together with additional apparatus. The additional apparatus includes an image capture device 15 located at a third site 14 communicating with a wireless access point 19. The wireless access point 19 is a location for an antenna, receiver or other device for receiving a wireless transmission. The LAN of FIG. 2 therefore comprises links the 27, 33 and the access point 19. It may be noted that the sites 14 and 16 may be adjacent to one another, e.g., in the same room, or more widely separated.

In an illustrative implementation of the systems 11, 111 of FIGS. 1 and 2, the 802.11b wireless technology is employed. As those skilled in the art will appreciate, 802.11b is a wireless Internet standard that operates in the 2.4 GHz band and can provide a nominal throughout of 11 Mbps (mega bits per second).

In the illustrative implementation, the RFID scanner 23 transmits events over a RS-232 serial communication link to a client application running on a high-end laptop computer 25 employing, for example, the Windows 2000 operating system. The computer 25 hosts a database 26 and is further equipped with an 802.11 PCMCIA card to implement the first wireless link 27.

In the illustrative implementation, the laptop 25 operates as a server and also hosts a client application, which interacts with the RFID scanner 23 via the RS-232 interface, as described hereafter in more detail. In other embodiments, the client application may run on a separate programmed digital computer arranged to communicate with the scanner 23. This second computer may then be arranged to handle communications over a wireless link between the client application and the server application. Since the data processing apparatus represented by the laptop 25 typically hosts the server, it will, at times, be referenced hereafter simply as the server 25. As those skilled in the art will appreciate, numerous forms of data processing apparatus using various operating systems can serve the purpose of computer 25. Additionally, in other embodiments, various communications links can be substituted for the RS-232 interface.

The portable display device 31 of the illustrative implementation may comprise an iPAQ Model No. 3670 personal digital assistant (PDA) as manufactured by COMPAQ Corporation. The iPAQ 31 is equipped with an expansion sleeve, as well as an 802.11 PCMCIA card to implement the second wireless link 33.

As those skilled in the art will appreciate, the iPAQ 31 includes a digital computer in the form of a microprocessor, as well as a display device controlled by the microprocessor. Any of a number of other PDA's may of course be employed. Additionally, in other embodiments, other portable devices may be used, such as laptop computers, digital pagers, and appropriately adapted cell phones.

The image capture device 15 employed in an illustrative implementation of the embodiment of FIG. 2 may comprise a Ricoh RDC-1700 equipped with an Ethernet LAN card. The device 15 may, of course, comprise other image capture devices, including such devices which capture an image in pixelated form employing CCD or CMOS device technology. The access point 19 may comprise an Aironet 340 access point as available from Cisco Systems, San Jose, Calif., or other suitable component.

As illustrated in FIG. 2, the camera 15, PDA 31, and server 25 each preferably have a unique address and, in particular, an Internet Protocol (IP) address selected to facilitate wireless web-based or internet communications. As will be discussed in more detail, the illustrative implementation of FIGS. 1 and 2 employs XML and HTML over the HTTP protocol. As indicated, the 802.11 protocol is used for wireless communications between the client, the server, and the iPAQ 31.

The RFID tag 20 includes an identifier comprising information which uniquely identifies a particular individual and distinguishes a particular individual from each other individual in the situation. In the illustrative implementations under discussion, the identifier simply comprises a number which is uniquely associated with that individual.

Overall operation of an embodiment according to FIG. 1 is illustrated in FIG. 3. According to step 35 of FIG. 3, the scanner 23 detects the presence of an individual by reading an encoded tag 20 associated with that individual. In step 37, information regarding that individual is then transmitted over a wireless link to the portable display device 31 and, pursuant to step 39, a selected portion of that information is displayed on a display portion 32 of the portable device. 31.

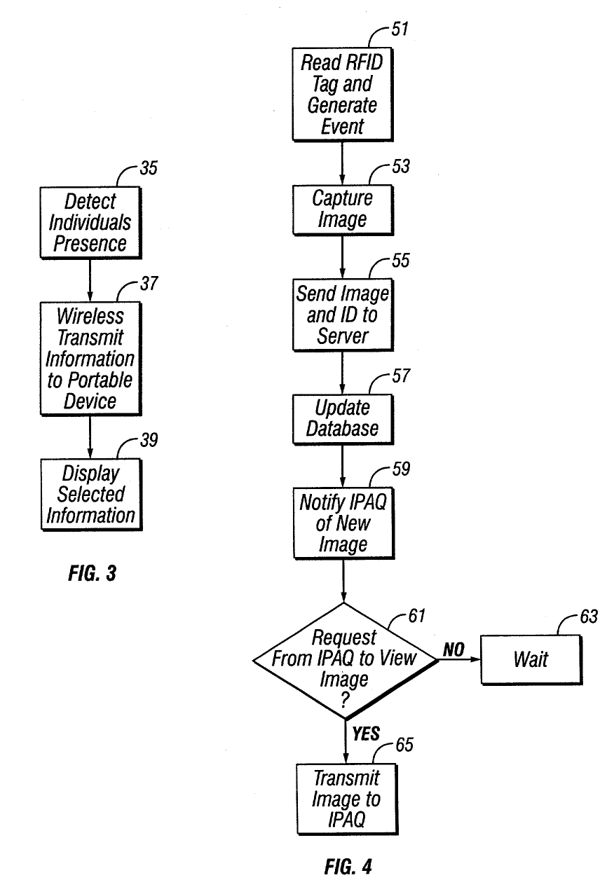

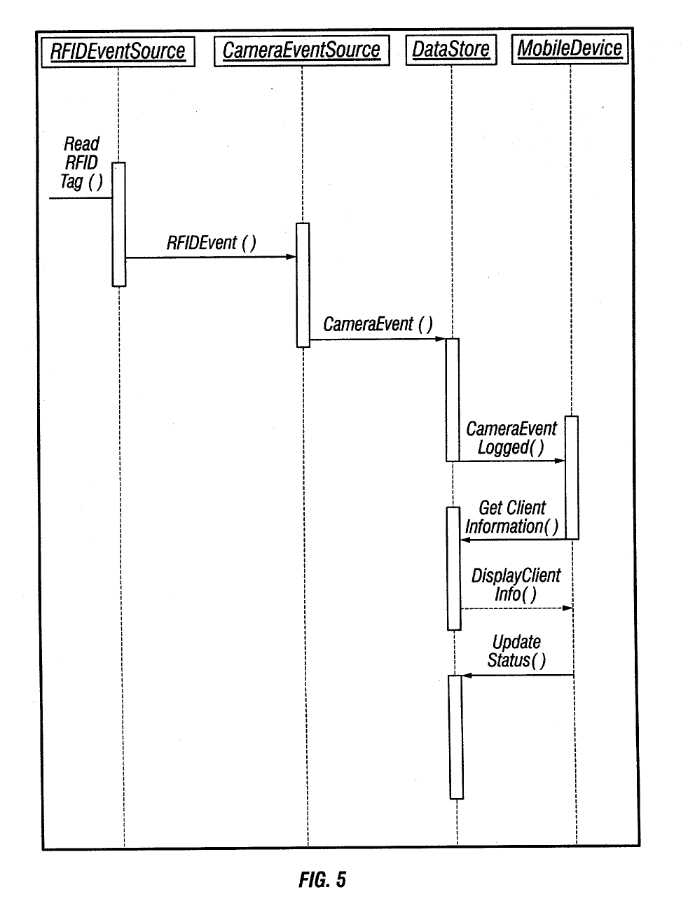

Operation of the illustrative implementation of the system of FIG. 2 will now be discussed in connection with FIG. 4. According to step 51 of FIG. 4, the scanner 23 reads the RFID tag 20 and generates an RFID Tag Event. No more than one such event may be triggered within a selected time period in order to avoid false triggers which might be generated as a result of the scanner 23 continuing to read the same tag 20. This mechanism to avoid false triggers is preferably incorporated into the RFID reader 23.

In response to generation of a RFID Tag Event, the client application causes transmission of a signal via the wireless link 27 to the camera 15. As indicated in step 53, this signal causes the camera 15 to capture an image of the individual who is wearing the RFID tag 20. The operation of camera 15 is initiated remotely over the wireless link by the client application via an HTTP request to capture and upload the appropriate image.

As indicated in step 55 of FIG. 4, the captured image and the corresponding identification number which has been read off the RFID tag 20 are then sent by the client application to the server application. The database 26 is then updated with the event id. This event id can then be used to locate the file where the image is stored.

As indicated in step 59 of FIG. 4, once the image is stored on the server database 26, a message is sent via the wireless network 34 to the mobile iPAQ device 31. The message notifies the individual using the iPAQ 31 that a new image is present. This notification preferably occurs within 5 seconds from the time the RFID tag 20 is read by the scanner 23. If the RFID tag 20 is not read, no image is sent.

As noted, each RFID tag 20 carries a unique identifying number, and each captured image is associated with the corresponding RFID number read off the tag 20. The RFID number is an index to a record stored in the database 26 for the particular individual whose picture was taken.

The client application is preferably designed to deal with cases where an RFID number is not in the database 26. In such case, the fact that such a number has been detected is recorded in a log. The client application also deletes the entry in the database field of the file name when it is determined that a captured image is not associated a valid RFID tag number.

After the user of the iPAQ 31 is notified that a new image has been captured, the user is provided the option at decision diamond 61 of viewing information about the individual whose RFID tag 20 was read. Specific information for provision to the user is stored in the fields of the database 26. Thus, in step 65, the image just captured at the second site 16 is automatically made available for viewing on the handheld iPAQ 31 located at the third site 18.

Additional capabilities may be provided in a system like that of FIG. 2. For example, the system may include the capability to collect statistics on RFID tags and images. Report specifications are defined for the number of tags read, invalid id number entries in the database, number of images recorded, etc.

Another capability which may be provided is the ability to administer the database records in order to add/update database information. Accordingly, import and export capabilities can be provided to interact with the database 26. An editor may also be provided to make minor changes to a given record. Mass import and export capabilities can be implemented using either Microsoft Excel or Access.

The system may further include the ability to transmit a customer's status to the iPAQ 31 for display to the iPAQ user. The iPAQ user may thus be alerted to the fact that a meeting between a host and a particular customer has occurred. The system may further include the ability to provide to the iPAQ 31 a list of people that have entered the room and whose RFID tag 20 has been read.

It is desirable to employ a RFID reader which possesses the ability to read tags up to one meter away, although a shorter range may be used. In the implementation described above, there is no requirement to account for the speed at which the person is moving through the scanner 23, nor is the scanner 33 required to distinguish more than one RFID tag at a time. However, such a capability can be provided if desired. In particular, in a more complex system, multiple i.d. tags may be read and information related to a respective subset of the tags transmitted only to respective selected portable display devices.

As those skilled in the art will appreciate, there are a wide variety of presently available RFID scanner/tag systems. While an RFID scanner-RFID tag system is preferred, other systems employing other forms of machine readable encoded tags may be used, such as, for example, Bar Code or magnetic strip technology.

### System Software Architecture

The following discussion addresses program design considerations for the implementation of System 11. Specific design issues addressed include event sequencing and choices for programming the iPAQ 31.

With respect to event sequencing, the overall design is an event flow model with events being generated by the RFID Reader 23, being processed by the client, and then the associated information being sent to a datastore which updates files/database records with the associated information. The mobile (iPAQ) client application uses a polling mechanism to determine if any events are available for it. The polling mechanism is implemented via a web service model wherein an HTTP request is repeatedly sent to a servlet which returns the time at which an event last occurred (the “last event time”). The iPAQ application uses this last event time to determine if a new event has occurred.

### iPAQ Client

With respect to the iPAQ client application, two approaches have been identified. The basis for both approaches is to render the display in HTML using JSP (Java Server Pages) on the server to dynamically generate the necessary output. This method allows rapid changes to the appearance of the client application, without the need to recompile an application after editing.

The only variable in choosing the application approach is in deciding where to house the HTML control. This control can simply comprise the control as it exists within Internet Explorer or a separate control housed in a VB application.

In one implementation, a VisualBasic application has been employed which includes the use of an embedded HTML control for displaying the main portion of the application screen using HTML rendered on the server. An ActiveX control in C⁺⁺ is used to access the event queue. The timer mechanism in VisualBasic checks the queue on a periodic basis (currently set to five seconds), and gives an indication to the user when new events show up in the queue.

Additional specifications for the processing of the Event Queue include the following:

1. When polling, the servlet returns the time as to when the last RFID camera event occurred.

2. If there is a new event, newer than the previous newest, then someone new has arrived and an alert is sent to alert the iPAQ user (audible alarm). Otherwise the list is just updated with any status changes which may have occurred.

3. A new page is created to view the entire list of persons who have arrived when a new entry is added or a status change is made.

FIG. 5 is a UML diagram reflecting the logical architecture of the software of the system under discussion. The diagram illustrates the various transaction states which exist: Read RFID Tag ( ), RFIDEvent ( ), CameraEvent ( ), CameraEventLogged ( ), GetClientInfo ( ), DisplayClientInfo ( ), Update Status ( ). In the first state, the server 23 is waiting to detect a tag 20. Detection of a tag 20 triggers the second state wherein the camera 15 operates to capture an image. Upon capture of an image, the third state is entered wherein the image data is stored and the occurrence of a detection event is logged, causing entry into the fourth state wherein the mobile (portable) device (iPAQ) is notified that a particular individual has entered the room/been photographed. In the next state, the mobile device 31 requests the information from the database regarding the particular individual (client). The next two states reflect the response to the request wherein the information regarding the individual is provided to the mobile device and the transmission of a selected change in status from the mobile device back to the datastore.

The specific logical components that are needed by the client application running on the server computer 25 include the following:

RFID Tag Reader Component—Component used to capture RFID Tag Events. These events are sent to the Image Capture Component.

Image Capture Component—Used to capture an image and associate it with the RFID Tag Event. The Image Capture event is sent to the Update DBMS component.

Update DBMS Component—Used to log the information into the database for reporting and web display. This component generates a RFID Tag Event DB update which is sent to the Mobile Event.

DBMS Data Store—This component is used to capture the events and tag related information.

DBMS Lookup Component—This component performs database look-ups and formats the data for display on the appropriate display device.

The following server components are developed in Java:

RFIDEvent—The event generated by an RFIDEventSource.

RFIDEventSource—The RFID serial port reader source, creates an RFIDEvent and sends them to any/all RFIDEventListeners. It runs in its own thread of control listening to the serial port for events.

CameraEvent—The event generated by the action of taking an image via a camera.

CameraEventSource—The CameraEvent contains information about the image and is delivered to any/all CameraEventListeners. The CameraEventSource also runs in it's own thread of control. The implementor of the CameraEventSource must implement the RFIDEventListener interface to listen for RFIDEvents. These events are placed into a queue which is monitored by the CameraEventSource and act as the impetus for the picture being taken.

PollEvent—This servlet is accessed by an iPAQ client attempting to determine if any events have occurred which might interest it. Data is requested via an XML message and any information is returned in the same manner.

ReportingPage Java Server Pages (JSPs)—These are a set of data driven JSPs which can be accessed via a Pocket PC Internet Explorer.

The following iPAQ client component is written in C++:

MobileDeviceMonitor—This component monitors the MobileEventQueue by polling the associated servlet on a regular interval. When it determines that a new event occurs it signals the user with an audible alert warning. The device then allows the user to display information about the event in an HTML rendering. The HTML information is obtained via the ReportingPage JSPs. In addition, the user may indicate the disposition of the event from a simple selection list. Once disposed of, the event is removed from the server side DB event table, however, log information is retained by one of the ReportingPage JSPs.

### Data Model

The following schema are implemented in the database 26:

User table—used to hold user details

| Field Name | Attributes |
|---|---|
| exdetails | varchar(100) |
| title | varchar(35) |
| company | varchar(50) |
| lastname | varchar(50) |
| firstname | varchar(50) |
| tagid | varchar(100) |
| personnalbio | varchar(1000) |
| companybio | varchar(1000) |

EventQueue—entry created when camera event occurs

| Field Name | Attributes |
|---|---|
| eventid | int |
| tagid | varchar(100) |
| time | long (time milliseconds as per java) |
| status | int (one of pre defined status values) |
| imagelink | varchar(50) |
| logicaldelete | boolean |

Status table—used to hold mapping of status to gif image.

| Field Name | Attributes |
|---|---|
| description | varchar(50) |
| imagelink | varchar(50) |
| status | int |

### iPAQ Screen Displays

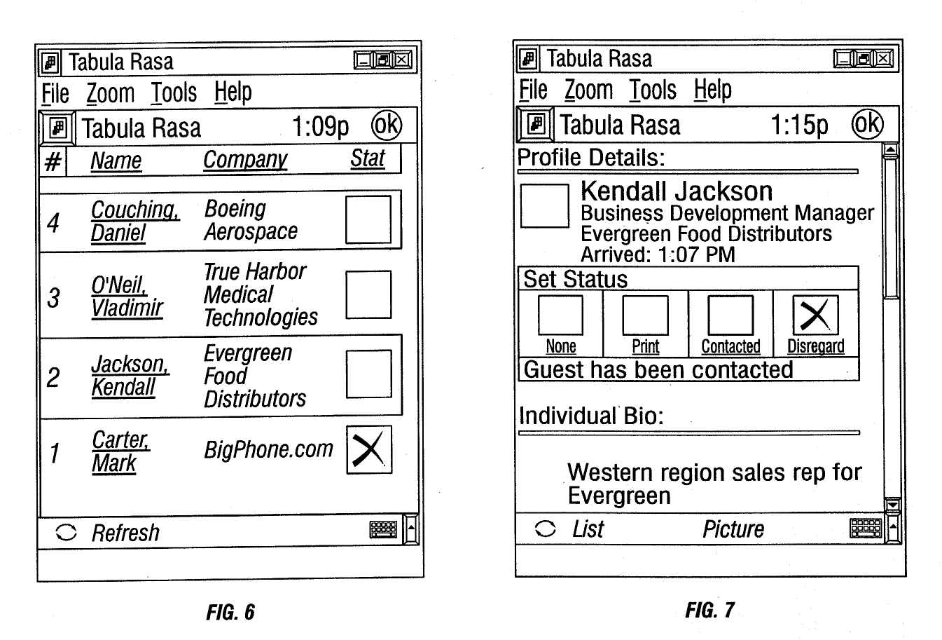

Three screen displays designed for the iPAQ device 31 will now be described. Visual metaphors from Microsoft Outlook are used on the main List screen (FIG. 6) to indicate whether a person's profile has been viewed. Bold indicates an unread listing, plain text represents that the listing has been read. New entries to the system are displayed in Bold.

The displayed list of individuals, by default, is sorted by the chronological order in which guests have checked in. The list may be alphabetically sorted by Name or Company by clicking on the underlined column header.

Sorting by status can also be performed. The order of items when sorted by “Status” may be in the following sequence: “blank” items (these are in bold font) “Star” items, “Check Marked” items, and finally “NO-sign” items.

The second screen illustrated in FIG. 7 provides additional information pulled from the database 26 about the specific guest selected. This screen also provides the user with the opportunity from this screen to set the status marker for the guest. Selecting “None” leaves the listing unmarked.

Red Star—Need priority attention.

Blue-green “happy face”—Guest has been contacted.

Black X—means this guest has been contacted already and others should disregard this lead.

By selecting one of the status icons by a “point and touch” or other operation, the screen is refreshed and the newly assigned Status icon is displayed by the Guest name. The respective status icon from the list is also shown in an “active” state. Following the process of marking the status of the guest, the user may return to the list screen or display a picture of the guest.

A third screen (not shown) is employed to display the image of a guest captured by the camera 15. This screen again includes a “List” button to return the user to the list screen. A “Details” button provides the user with expanded details about the guest they have selected.

One exemplary application for the apparatus described above is at conferences and hospitality suites. Preferred guests are given an RFID card 20 either prior to or during a conference or show. This card 20 is encoded with an identification number. The identification number has a reference id to a database entry that contains relevant business information regarding this individual, i.e. name, title, company, address, personal biographical data, etc. When the individual appears at the hospitality suite, the RFID reader 23 identifies the individual, a picture is taken and a notice then sent to specific hosts with PDA devices 31 who have been designated to locate and speak to the guest entering the room. The PDA device 31 has the capability to query the server containing the database 26 for other relevant information. The PDA device 31 also has the capability to update the database 26 as to the disposition of the notification after the person has been contacted.

Another feature which may be provided is the capability to develop a voice record file on the iPAQ 31, which may comprise notes of the conversation or personal follow-up message. The iPAQ 31 then transmits these messages for storage by the database 26. With respect to the voice record of a conversation, the record is merely stored. However, with respect to the personal message, the system can be made operative to transmit it via e-mail or pager to the individual.

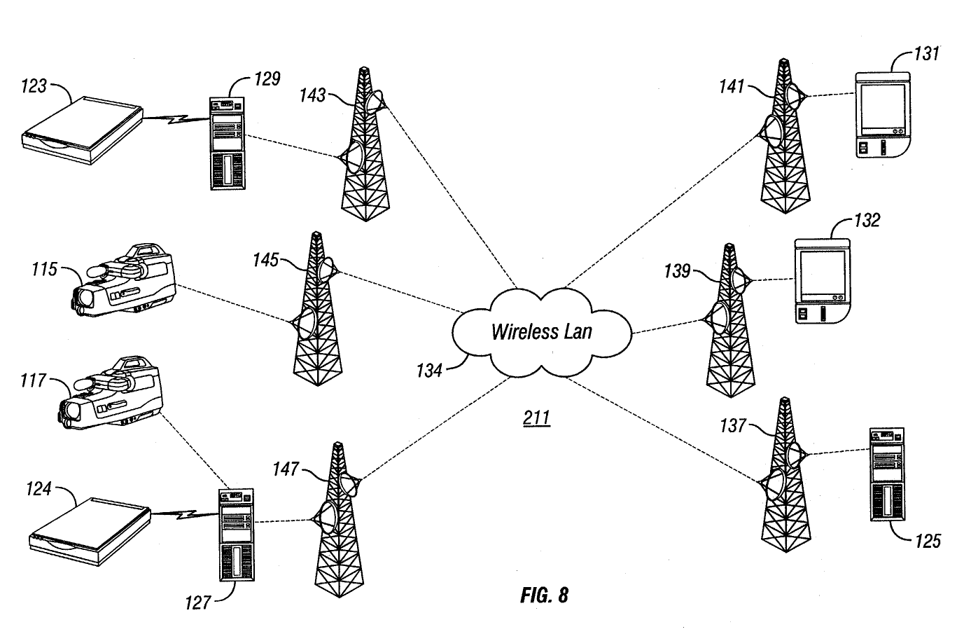

FIG. 8 illustrates a third embodiment reflecting various methods and apparatus combinations according to the invention. The embodiment of FIG. 8 employs a database server 125 communicating through a wireless link 137 with a wireless LAN 134. Communication may also be established with first and second portable display devices 131, 132 through the LAN 134 via respective wireless links 139, 141. Respective RFID scanners 123, 124 are arranged to transmit, e.g., via respective RS232 interfaces, with respective RFID servers 129, 127.

The servers 129, 127, in turn, may communicate via wireless links 143, 147 with the server 125 via the LAN 134. The server 125 maintains a database 126. The server 125 may, of course, comprise various combinations of computer hardware, such as a personal computer (P) with a self-contained database or other computer apparatus interfacing with an external or discrete database component.

FIG. 8 further illustrates a digital camera 115 disposed in conjunction with the RFID scanner 123 and arranged to communicate via a wireless link 145 with the server 125, for example, as disclosed in connection with the embodiment of FIG. 2. A USB camera 117 is connected to communicate with the second RFID server 127, for example, by a hard wire connection. In an embodiment according to FIG. 8, numerous portable display devices, e.g., 131, 132, and/or numerous additional RFID scanners, e.g., 123, 124, with or without associated image capture devices, may be included.

Particular features which may be implemented in connection with an embodiment of FIG. 8 include (1) the support of multiple portable display devices 131, 132, such as multiple iPAQs; (2) the option of operating a particular scanner site with or without an image capture device, e.g., such as a camera; (3) the ability to support different kinds of cameras of varying expense; (4) the provision of a pull-down menu on the iPAQ containing a list of possible status changes to be sent to the database server 125; (5) the ability to create a server log reflecting who made status changes, what the previous status was, and what it was changed to; (6) the ability to update the database with individual information “on the fly;” (7) the ability to use a pre-existing photograph of an individual and then overwrite it with a subsequently captured one; and (8) the ability to automatically clear the database 126 residing on the server 125.

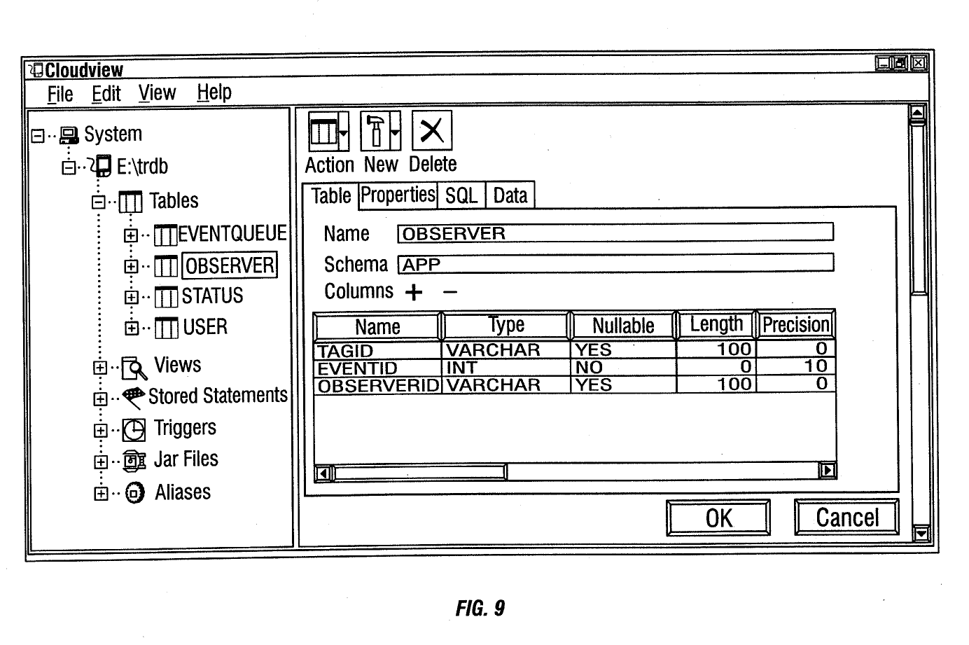

A particularly useful feature implemented in connection with a system like that of FIG. 8 is the capability to automatically direct information regarding a first detected individual to a first portable display device, e.g., 131, while information regarding a second individual is automatically directed to a second portable display device, e.g., 132. In this manner, different persons holding the respective display devices can be respectively assigned to, e.g., interview the respective first and second individuals and the transmission of information regarding those individuals can be automatically routed to the proper interviewer. In general, selected information regarding selected groups of individuals may be automatically routed to selected ones of a numerous group of portable display devices. A database structure which facilitates this operation is illustrated in FIGS. 9-12.

The following are table and column descriptions for the database illustrated in FIGS. 9-12:

Table: OBSERVER—FIG. 9

The observer table is used to associate specific tags with specific iPAQs (or other client devices).

When an event occurs for a specific TAGID, a lookup in this table allows the client device to obtain all the tags that have been assigned to the device.

TAGID: The text column that contains the serial number from the RFID tag. A foreign key reference to the TAGID column in the USER table.

EVENTID: Not used in particular implementation but may be in others (“NU”).

OBSERVERID: The client device IP address that receives notification for the given tag

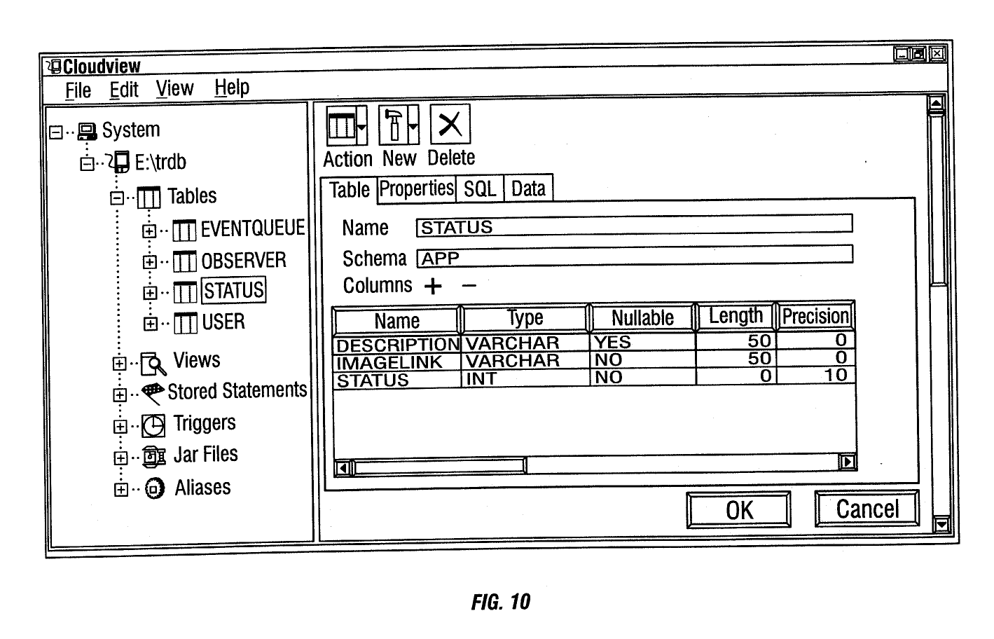

Table: STATUS—FIG. 10

The status table provides the description and background color for display on the client device. The description is used in a pull down menu on the user details page. The background color is used on both the user details page, and the event list page to help indicate the current status assigned to an individual holding a tag.

DESCRIPTION: The text string to display on the client device when assigning status to an individual. The string is also displayed in a key that helps the client device operator to associate a background color with a status (when viewing the event list page).

IMAGELINK: A string containing the background color as a hex value for red, green, blue.

STATUS: The primary key for the table.

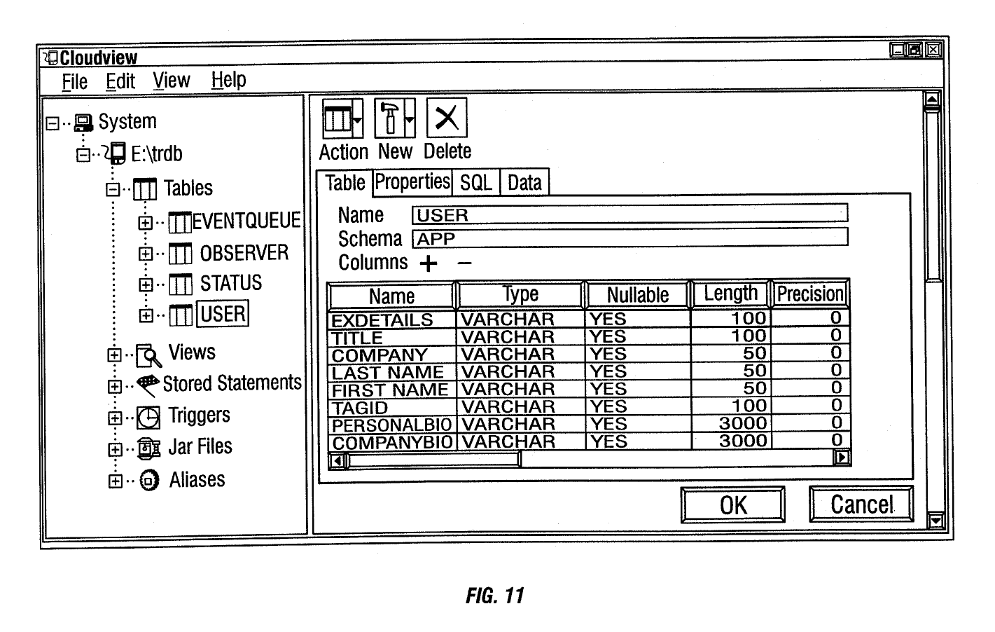

Table: USER—FIG. 11

The user table contains all data about individuals who possess tags. When an individual triggers an event by passing their tag by an RFID reader, this data is displayed in specific forms on the client devices.

EXDETAILS: NU

TITLE: The individual's company title

COMPANY: The individual's company name

FIRSTNAME: The individual's first name

LASTNAME: The individual's last name

TAGID: The assigned tag's serial number. The table's primary key value.

PERSONALBIO: A “|” delimited string that contains a list of personal information for the individual. This list will be displayed as bulleted items on the user details page.

COMPANYBIO: A “|” delimited string that contains a list of company information. This list will be displayed as bulleted items on the user details page.

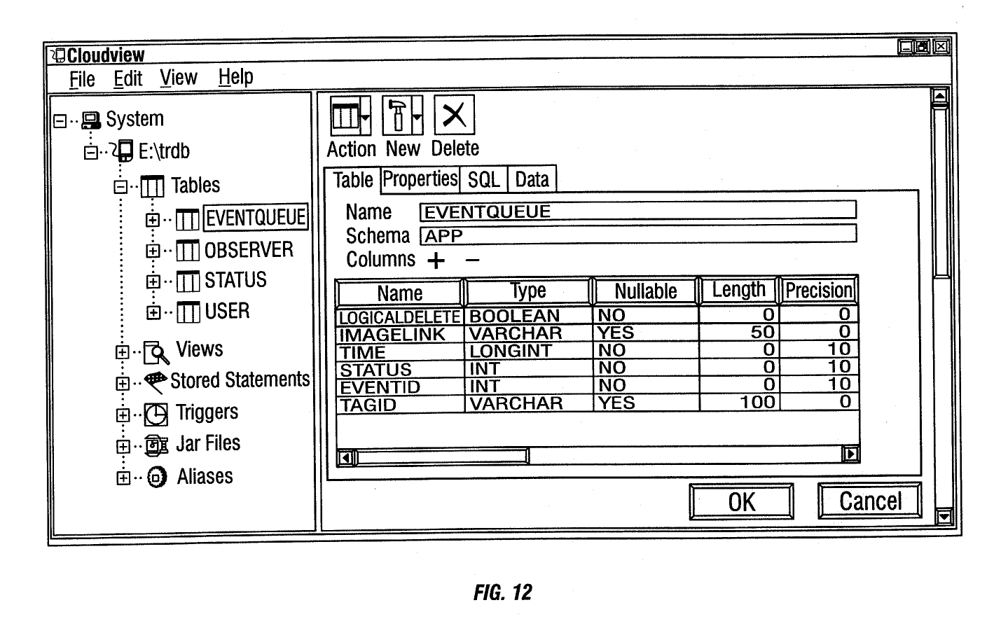

Table: EVENTQUEUE—FIG. 12

Every time that an individual passes their tag by an RFID reader, an entry is made in this table. Used in concert with the other tables in the database, this information allows the client devices to obtain information like the individual's picture, their time of arrival, and their status. Updates to an individual's status are made to this table.

LOGICALDELETE: NU

IMAGELINK: An identifier for the optional picture taken when the user passed their tag by an RFID reader.

TIME: The time when the user passed their tag by an RFID reader.

STATUS: A foreign key reference to the status table. Client devices can update which status value is assigned to the individual.

EVENTID: The primary key for the table

TAGID: A foreign key reference to the user table, containing the tag passed by the RFID reader.

The logical architecture reflected in FIG. 5 may again be employed in an illustrative implementation of FIG. 8 and the just described database structure.

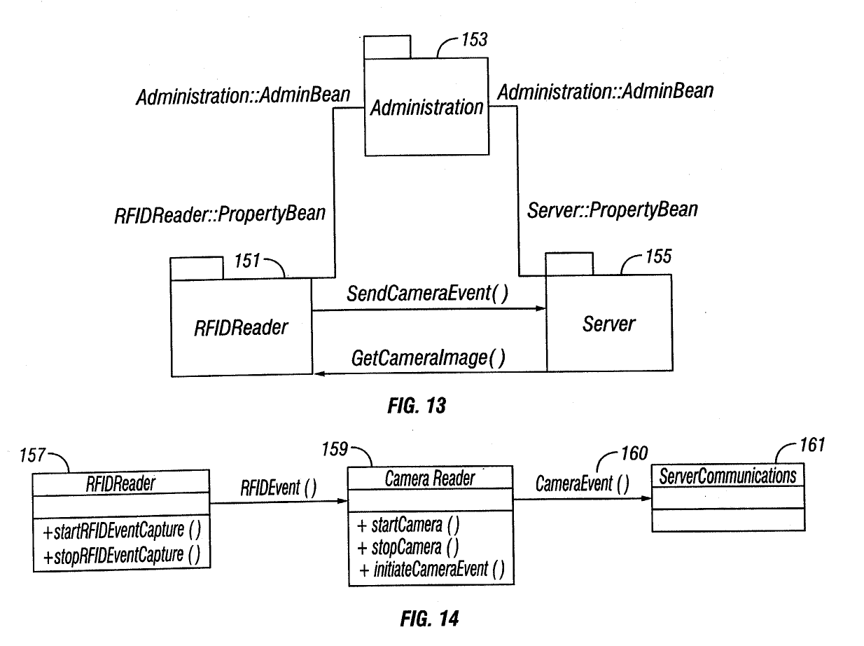

An alternate software implementation directed at facilitating database administration is shown in FIGS. 13-17. This implementation employs three major components (applications) 151, 153, 155, on the server side, as shown in FIG. 13. These components are the RFID reader package 151, the Administration package 153 and the Server package 155.

As shown in FIG. 13, the RFID reader package or application 151 is constructed with three major classes: RFID Reader 157, Camera Reader 159, and Server Communications 161. It is an event-driven operation, where the major actor is a person carrying an RFID tag.

According to FIG. 13, a tag is read and sent to the camera class 159 for processing, e.g., taking a picture of the person. An event is then sent via the communication layer to the server 155. The server 155 requests the copy of the image and downloads it to the datastore 126, thereby completing the event flow for the RFID/Camera application.

The communications between the three separate components 151, 153, 155 needs to be asynchronous. Therefore, a queuing framework is created to allow non-guaranteed, in-memory queuing of the events between the various components 151, 153, 155. This queuing framework allows each of the components 151, 153, 155, to work independently in time without one “blocking” the other.

Additionally, the RFID reader, e.g., 123, 124, can be “disabled.” In such case, all events are stopped, and the communications port is released for other applications to read the tag if needed. Disabling a reader 123, 124 is accomplished via a message from the Administration application 153.

Finally, the Camera class 159 can be “disabled.” This forces the camera to “not” take a picture. The RFID event is then translated into a “dummy” event and sent to the communications class 161. Again, this function is implemented with a message sent via the Administration application 153.

The server application 155 has two major functions. The first major function is to accept events sent to it from the RFID/Camera application. Transmission of events is accomplished via HTTP messages. Alternatively, SOAP messaging may be used.

The second major function of the server application 155 is to provide information for the iPAQ application. The application 155 includes a function which enables the use of multiple iPAQ devices; e.g.,. 131, 132. In addition, an alert is generated whenever a status change or new RFID event occurs. In order to support this feature, the database structure allows for the storage of the last event information on a person-by-person basis.

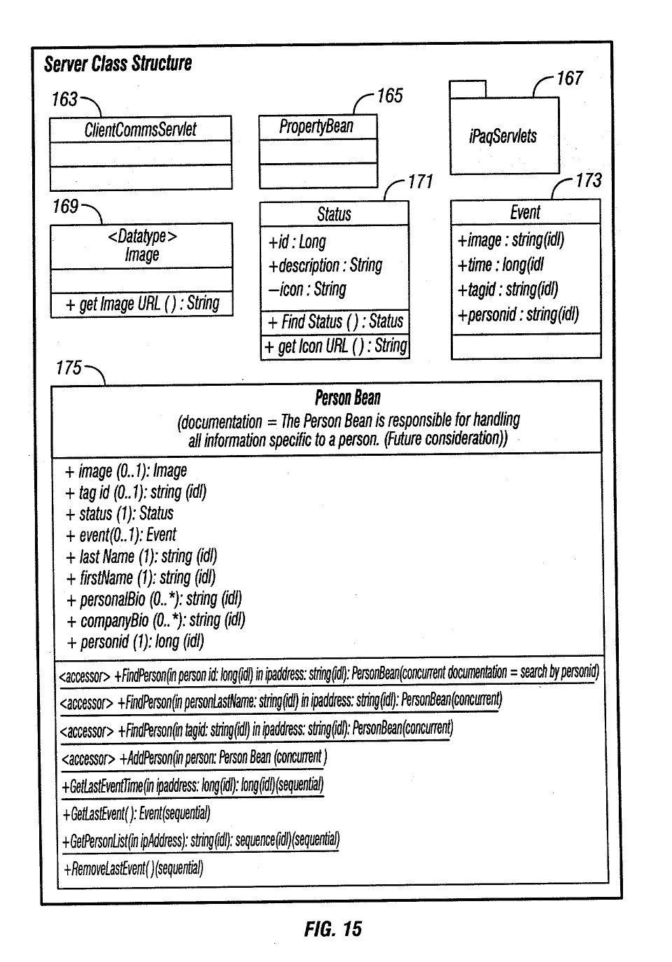

The chart shown in FIG. 15 shows an illustrative Server Class Structure for server 155. This structure includes the classes Client Comm Servlet, Property Bean, iPAQ Servlets, Image, Status, Event and Person Bean.

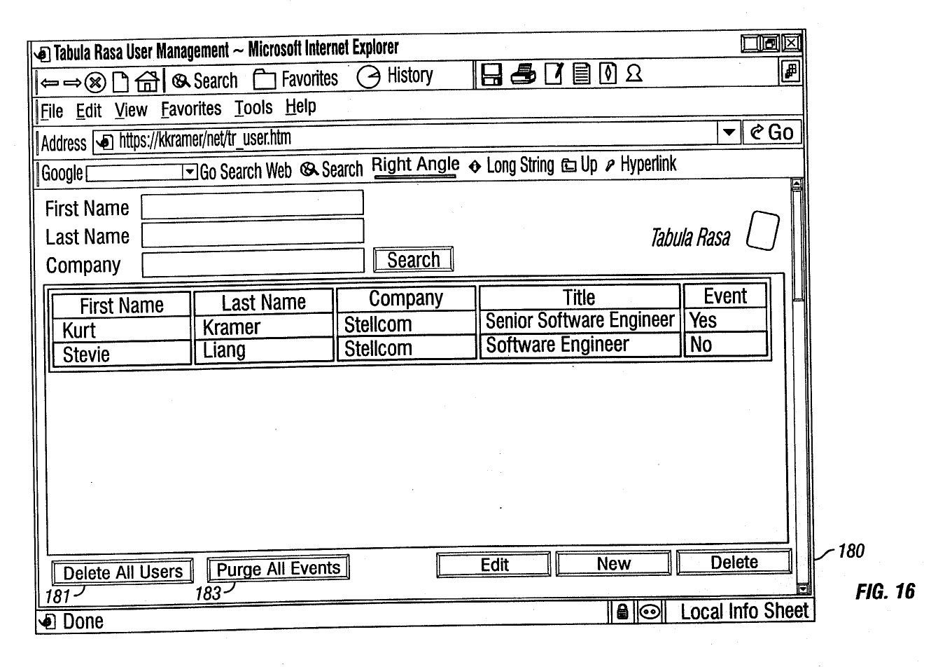

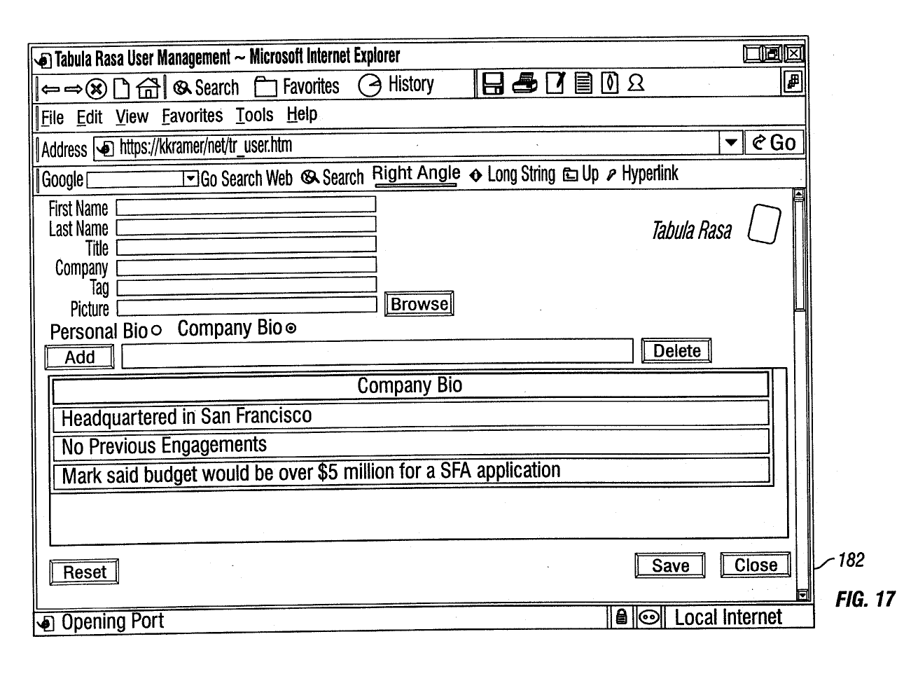

With respect to the administration package 153, a pair of screens 180, 182 shown in FIGS. 16 and 17, respectively, allow for database administration. As may be noted, the client administrative screen 180 of FIG. 16 permits all users to be deleted and all events to be purged via respective buttons 181, 183. The screen 182 of FIG. 17 permits editing of personal and company information.

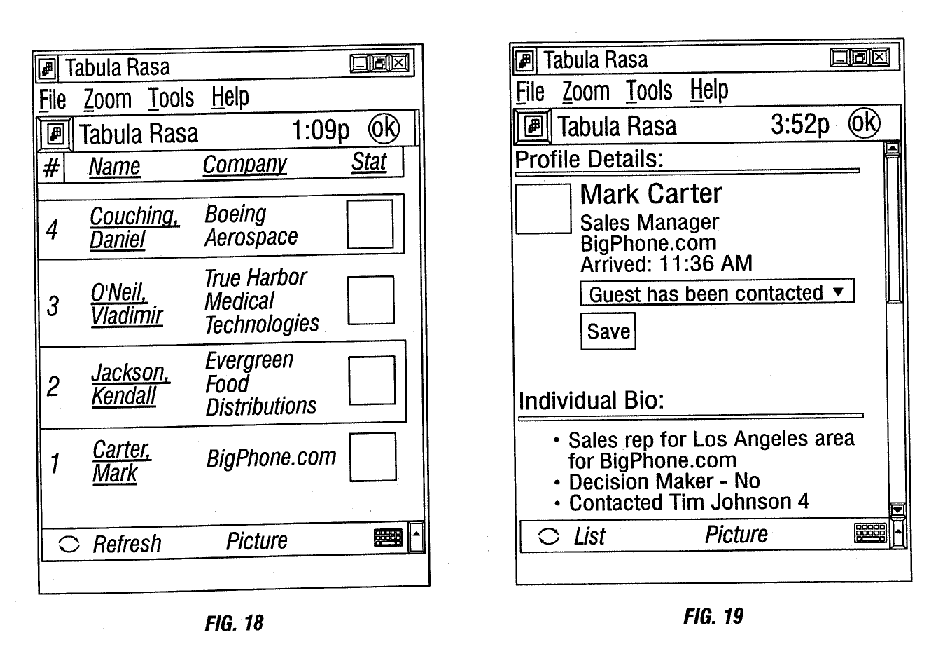

Additional alternative iPAQ display screens are illustrated in FIGS. 18 and 19.

### Wireless Technologies

Preferred wireless technologies which may be used in various embodiments employ the unlicensed Industrial, Scientific and Medical (ISM) bands, although other wireless communication frequencies can be used. The term “ISM bands, refers to frequency bands allocated by the FCC that were originally intended to allow electrical and mechanical equipment to radiate unintentional RF energy (at specific frequencies), without interfering with wireless communication applications operations in other frequency bands. Originally, wireless communication was not included in the ISM bands because of interference (the noise) in the environment. With the development of a technique known as spread spectrum it is possible to enable wireless communications in these ISM bands. The FCC decided that as long as its rules are obeyed no license is required to operate a wireless system in these ISM bands.

The spread spectrum technique allows RF circuitry to distinguish one digital RF signal from another when both are operating at the exact same frequency and in the same geographical location. There are two forms of spread spectrum. One is Direct Sequence Spread Spectrum (DSSS) and the other is Frequency Hopping Spread Spectrum (FHSS). DSSS refers to spread spectrum modulation of the signal where the transmitted signal is modulated with a special code and the receiver has the complementary code and is thus able to decipher the signal it receives. FHSS is similar to DSSS, except that the transmitted frequency is instantaneously and continuously changed according to a special code. Since the receiver has the same code, it knows what frequencies to look for when receiving and thus is able to decipher the signal. The act of modulating the signal with a special code “spreads” the bandwidth of the signal over a wider frequency range as it travels from the transmitters to the receiver. RF technologies, like Bluetooth, that use spread spectrum operate at frequencies above GHz.

Several short-range wireless technology options exist that occupy the frequency band of 2.4-2.4835 GHz of the radio spectrum, including Bluetooth, 802.11, and radio frequency identification (RFID).

The specific characteristics of each technology will be outlined in more detail.

### Radio Frequency Identification (RFID)

The attractive quality of RFID tag technology is that the tag itself contains no internal power source (is passive) and derives power from the receiver or reader. Once the tag is powered, an electronic circuit becomes operative, which in turn sends a signal back to the reader. The trend for the growth of this technology is that the RFID tags are becoming tiny, cheap and easy to deploy. Recently, the advancement in printed circuitry in the RF arena has propelled this trend. Conductive inks can be used to form the antenna on a tag thus driving down the cost of the RF hardware and the power requirements.

### 802.11, 802.11a and 802.11b

This family of wireless technologies refers to the specification of Ethernet local area networks (LANs). Wireless products based on the 802.11 standard were originally developed for data only and would be used by corporations to facilitate mobile/wireless computing inside an office environment. Key characteristics of this technology include a larger range (up to 100 meters), faster data rates (1-2 Mbps for 802.11, 54-72 Mbps for 802.11a, and up to 11 Mbps for 802.11b) and greater consumption. 802.11, the original standard has been surpassed by other protocols because of faster data rates. 802.11 uses DSSS and is incompatible with Bluetooth while 802.11a employs OFDM (Orthogonal frequency-division multiplexing) and is still in development.

### Bluetooth

This more recent short-range wireless technology was conceived to provide the interconnectivity of devices. Connections can be point-to-point or multipoint, with a relatively mid-range capability of ten meters. Currently, data rates approximate one megabit per second (Mbps), with this rate increasing to two Mbps in second-generation devices (available circa 2002 ). Bluetooth uses a frequency hop scheme (FSSS) that enables devices to communicate even in areas with substantial interference. Built-in encryption and verification is also provided. The advantages of Bluetooth include low power consumption, the ability to be device agnostic, and the ability to establish small local networks (piconets) that permit wireless information transfer. The main disadvantages are the relatively expensive cards, relatively short ranges, and interoperability with all other forms of wireless local area networks.

### HomeRF

This industry standard was designed for wireless products for use in the home networking environments and competes with 802.11 and 802.11b. The relative advantages of this protocol are wider range, fast data rate, facilitation of both data and voice (compared to data-only 802.11), and less expensive to install than 802.1 b. Operating within the 2.4 Ghz, HomeRF has a range of up to 150 feet at maximum throughput. Presently available HomeRF products offer 1.6 Mbps, however an FCC approval in August 2000 will spark the introduction of faster wireless products using the 10 Mbps speed by the first half of 2001. This ruling was important to the ability for HomeRF vendors, enabling them to compete with the 11 Mbps speeds of 802.11-based products. The main drawback of HomeRF is interoperability with 802.11b and Bluetooth.

### HiperLAN2

This wireless technology bears remarkable resemblances to 802.11 and was developed by the ETSI (European Telecommunication Standardization Institute) to operate in the 5 GHz band. Though it is a European based standard, its operating band range makes it easily usable within the US and Asia where the 5 GHz band is also unlicensed. This protocol offers high-speed, wireless connectivity with up to 54 Mbps and seamless connectivity with corporate LAN, 3G cellular systems, mobility for future applications such as multimedia, voice over Internet protocol (VOIP) and real-time video. A significant difference between HiperLAN2 and 802.11a is how each standard addresses the QoS (Quality of Service) issue, 802.11a has wireless Ethernet capabilities that were extended to this band from other 802.11 specifications. HiperLAN2, supports time critical services and asynchronous data and is compatible with ATM, 3G, 1394, and IP networks. Finally, the protocol provides transmit power control and dynamic frequency selection, which should provide greater spectrum efficiency and lower interference probability with other systems operating on 5 GHz.

### Custom RF Solutions

There are numerous options for customizing a wireless solution for a variety of needs. Customization usually dwells within the 900 MHz band because of the large number of consumer oriented components, devices and products traditionally employed there. Data rates are often lower that some of the more recognized standards, typically varying from 14 kbps-100 kbps. A customized solution permits specialized products and services that cannot utilize standardized RF solutions because of technical, environmental or economic considerations. Depending upon the complexity certain customized solutions can provide significant cost savings by incorporating simple, reliable and inexpensive technologies. Though not as robust as recent protocols such as Bluetooth and the 802.11 series, a customized solution permits functional wireless products to come to market as the other protocols gain momentum and significantly lower price points.

The methods and apparatus of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

While the present invention has been described above in terms of specific embodiments, it is to be understood that the invention is not limited to the disclosed embodiments. On the contrary, the present invention is intended to cover various modifications and equivalent structures included within the spirit and scope of the appended claims.

What is claimed is:

1. A method comprising the steps of:
detecting the presence of an individual by reading an encoded tag associated with that individual;
automatically responding to the detection of said individual by transmitting information regarding that individual over a wireless link to a portable display device; and
displaying a selected portion of said information on a display portion of said display device.

2. The method of claim 1 wherein said encoded tag comprises a radio frequency identification (RFID) tag.

3. The method of claim 2 wherein said step of detecting is performed by an RFID scanner.

4. The method of claim 2 wherein said selected portion of said information is displayed on said display portion in response to a selection operation performed on said device by a second individual.

5. The method of claim 1 wherein the step of automatically responding is performed by apparatus including a programmed digital computer.

6. The method of claim 1 further including the step of automatically responding to detection of said individual by capturing an image of said individual and transmitting said image over a wireless link for display on a portable display device.

7. The method of claim 6 wherein said step of automatically responding to the detection of said individual comprises the steps of:
transmitting a signal over a wireless link to a device adapted to capture said image; and
causing said device to capture said image in response to said signal.

8. The method of claim 7 wherein a programmed digital computer is programmed to execute the step of automatically transmitting said signal over a wireless link to a device adapted to capture said image.

9. The method of claim 6 wherein a digital computer is further operative to incorporate said image into said information transmitted to said device.

10. The method of claim 7 wherein said digital computer is further operative to incorporate said image into said information transmitted to said device.

11. The method of claim 1 wherein said portable display device comprises a personal digital assistant (PDA).

12. The method of claim 6 wherein said portable display device comprises a personal digital assistant (PDA).

13. The method of claim 1 wherein said portable display device includes a computer and a display controlled by said computer.

14. The method of claim 1 wherein said encoded tag comprises a Bar Code.

15. The method of claim 1 wherein said encoded tag comprises a magnetic strip.

16. The method of claim 1 further including the step of automatically responding to detection of said individual by transmitting a video of said individual to said portable display device.

17. The method of claim 1 wherein said encoded tag includes an encoded identifier uniquely associated with said individual.

18. The method of claim 17 wherein said encoded tag further includes encoded information concerning said individual in addition to said identifier.

19. The method of claim 6 wherein said encoded tag includes an identifier uniquely associated with said individual.

20. The method of claim 19 wherein said encoded tag further includes information concerning said individual in addition to said identifier.

21. The method of claim 6 wherein images of a plurality of different individuals are successively captured in response to reading of a succession of encoded tags, each tag associated with a respective one of said individuals, each tag including an encoded identifier uniquely identifying a respective individual.

22. The method of claim 21 wherein each successive image comprises at least a portion of a record stored in a database and wherein each said identifier comprises an index to a respective record stored in said data base.

23. The method of claim 22 further including the step of causing said portable display device to query the database for information contained therein regarding a selected individual.

24. The method of claim 22 further including the step of causing the portable display device to update the database as directed by the user of the portable display device.

25. The method of claim 22 further including the step of causing the portable display device to transmit a message to the database.

26. The method of claim 22 wherein import and export capabilities are provided for interacting with said database.

27. The method of claim 22 wherein the capability is provided to update and/or add information to the database.

28. The method of claim 21 further including the step of causing a list of all individuals whose tags have been identified to be transmitted to the portable display device.

29. The method of claim 21 further including the step of providing an indication to said portable display device that an interaction has occurred with a selected individual identified by one of said tags.

30. The method of claim 22 wherein said portable display device is responsive to a voice message to encode said message and transmit it for storage in said database.

31. The method of claim 16 wherein said video is transmitted by a streaming video transmission.

32. The method of claim 25 wherein said message includes an e-mail intended for subsequent delivery.

33. The method of claim 21 wherein there is a plurality of portable display devices and further including the step of transmitting information regarding a respective groups of said individuals to a different respective portable device.

34. A method comprising the steps of:
storing information regarding an individual in a database;
detecting the presence of said individual by reading an encoded tag associated with that individual;
automatically responding to the detection of said individual by automatically transmitting information regarding that individual from said database to a portable display device; and
displaying a selected portion of said information to a second individual on a display portion of said portable display device.

35. The method of claim 34 wherein said encoded tag comprises a radio frequency identification (RFID) tag.

36. The method of claim 35 wherein said step of detecting is performed by a RFID scanner.

37. The method of claim 36 wherein the step of automatically responding is performed by apparatus including a programmed digital computer.

38. The method of claim 37 wherein said step of transmitting comprises transmitting said information over a wireless link.

39. The method of claim 38 further including the step of automatically responding to detection of said individual by capturing an image of the individual.

40. The method of claim 39 wherein said step of capturing an image comprises the steps of:
transmitting a signal over a wireless link to a device adapted to capture said image; and
causing said device to capture said image in response to said signal.

41. A method comprising the steps of:
detecting the presence of an individual by reading an encoded tag associated with that individual;
automatically responding to detection of said individual by automatically
capturing an image of said individual and automatically transmitting information regarding that individual over a wireless link to a display device, said information including said image.

42. The method of claim 47 wherein said encoded tag comprises a radio frequency identification (RFID) tag.

43. The method of claim 47 wherein said step of detecting is performed by an RFID scanner.

44. The method of claim 47 wherein the step of automatically responding is performed by apparatus including a programmed digital computer.

45. The method of claim 47 wherein said step of automatically capturing an image comprises the steps of:
transmitting a signal over a wireless link to a device adapted to capture said image; and
causing said device to capture said image in response to said signal.

46. A method comprising the steps of:
providing a plurality of guests at an event with a radio frequency identification (RFID) card, each card being encoded with a different identification code, each code uniquely identifying one of said guests; each code further comprising a code for use in accessing a database entry containing information regarding said individual;
automatically responding to detection of said RFID card to capture an image of said individual; and
automatically transferring said image to a portable display device carried by a host at said event.

47. The method of claim 46 further including the step of automatically causing said image to be included in the database entry containing information regarding that individual.

48. A system comprising:
a machine readable information bearing medium, said medium carrying information about at least one individual;
a machine disposed to read said information from said medium and including means for converting said information into a signal carrying said information for transmission over a selected communication medium; and
a digital computer adapted to receive said information, said digital computer being programmed to perform the step of responding to receipt of said information to transmit a record pertaining to said individual over a communication link to a portable apparatus.

49. The system of claim 48 further including a device adapted to capture an image of said individual and to transmit said image over a wireless link to said second digital computer.

50. The system of claim 49 wherein said second digital computer is further programmed to respond to receipt of said information to trigger said device to capture an image of said individual.

51. The apparatus of claim 48 wherein said information comprises an identification number uniquely identifying said individual.

52. The apparatus of claim 48 wherein said information-bearing medium comprises a RFID tag and said machine comprises a RFID scanner.

53. The apparatus of claim 48 wherein said record is stored in a memory associated with said computer.

54. The apparatus of claim 35 wherein said memory comprises a database.

55. The apparatus of claim 48 wherein said communication link is a wireless link.

56. A system comprising:
a machine readable information bearing medium, said medium carrying information about at least one individual;
a machine disposed to read said information from said medium and including means for converting said information into a signal carrying said information for transmission over a selected communication medium;
a portable apparatus including a first digital computer adapted to transmit and receive data via a communication link; and
a second digital computer adapted to receive said information and to communicate with said portable apparatus, said second digital computer being programmed to perform the step of responding to receipt of said information to transmit a record pertaining to said individual over said communication link to said portable apparatus.

57. The apparatus comprising:
a database; and
a plurality of entries in said database, each including an image captured by an image capture device and a unique code associated with said image, said code having been derived from an RFID tag.

58. The apparatus of claim 57 wherein said code comprises an index or an address.

59. The apparatus of claim 57 wherein said image comprises a digital representation of a photograph.

60. A method comprising the steps of:
detecting the presence of each of a plurality of different individuals by reading an encoded tag associated with each individual;
automatically responding to the detection of said individuals by automatically transmitting information regarding a first individual over a wireless link to a portable display device in the possession of a first person and by automatically transmitting information regarding a second individual over a wireless link to a portable display device in possession of a second person;

61. The method of claim 60 further comprising the step of displaying a selected portion of said information on a display portion of said display device.

62. The method of claim 60 wherein said encoded tag comprises a radio frequency identification (RFID) tag.
